(19) United States
(12) Patent Application Publication
(10) Pub. No.: US 2006/0156558 A1
(43) Pub. Date: Jul. 20, 2006

(54) Multipurpose framing and layout guide kit

(76) Inventor: Jimmy R. Owens, Flowery Branch, GA (US)

Correspondence Address: LITMAN LAW OFFICES, LTD, PO BOX 15035, CRYSTAL CITY STATION, ARLINGTON, VA, 22215, US

(21) Appl. No.: 11/034,736

(22) Filed: Jan. 14, 2005

(51) Int. Cl. B43L 13/02

(52) U.S. Cl. 33/42

(57) ABSTRACT

The multipurpose framing and layout guide kit has two components or guides, which are capable of accomplishing or assisting in virtually every measurement, layout, marking, and scoring function that may be required in the construction of a conventional frame structure. The first component comprises a triangular protractor having degree, common rafter slope, and hip/valley rafter slope scales thereon. A linear rule extends from one side of the triangle. The second component comprises a stud spacing gauge having a linear rule extending between the two stud spacing components. Each of the rules has a closed slot with a series of lateral notches therein for holding a marking, cutting, or scoring tool as the rule is moved over a panel surface. A fence or stop is provided at the first end of each rule and normal thereto for positioning and guiding the device relative to the edge of a panel.

### BACKGROUND OF THE INVENTION

1. Field of the Invention

The present invention relates generally to carpentry tools and devices. More specifically, the present invention is a kit that has: an elongate linear scale, including a protractor with multiple angle and slope scales; and a stud spacing gauge, including a linear scale. Both components include slots having a series of marking and cutting guide notches therein.

2. Description of the Related Art

Carpentry, and particularly the building construction trade, has traditionally utilized a number of different measuring and layout tools and guides in such work. Such devices range from rigid and flexible/retractable linear measuring rules, tapes, and chalk lines, to protractors for measuring and marking gable angles and slopes, to various linear, angular, and arcuate cutting and marking guides. The carpentry and construction world is replete with such tools and devices. Such tools and gauges are used throughout the construction of a building structure, with protractors and slope gauges, as well as linear measurement devices, being particularly valuable in the layout and construction of gabled structures.

Various attempts have been made to combine different features of such tools and devices into single devices in order to reduce the need to carry multiple tools to the job site in the field. Such combination tools are particularly valuable in the construction of gabled or angled structures, as noted above, where both angular and linear measurements, marks, and cuts are required. However, no single tool, device, or kit provides for all of the measurement and layout requirements for the construction of gabled structures, while also providing a gauge for conventional stud spacing layout for wall and gable framing.

Thus, a multipurpose framing and layout guide kit solving the aforementioned problems is desired.

### SUMMARY OF THE INVENTION

The multipurpose framing and layout guide kit has a pair of guides that, when taken together, provide essentially all of the measuring, layout, marking, and cutting guide and tool features required for the construction of a conventional frame structure having a gabled roof. The first component comprises a right triangular protractor having scales for angular degrees and common and hip/valley rafter slopes. The protractor includes an elongate linear measurement scale or rule extending from one of the two right angle sides. The second guide comprises a linear measurement rule having an open stud gauge slot at one end and a stud alignment stop at the opposite end. The stud slot is placed about a wall or gable stud and the next stud is positioned adjacent the stop to provide proper spacing (e.g., sixteen inches on center) between studs during construction. The span between the stud slot and the stop includes an elongate measuring rule.

Each of the gauges or components of the present kit includes an elongate closed slot formed in the general center of the measuring rule portion, with each slot having a series of laterally disposed marker or tool notches therein. These notches permit the marker or tool to be positioned accurately therein as the gauge is drawn along or over a surface to cut, mark, or score the surface as desired. In each component a fence or stop is provided normal to the measuring rule with its slot and notches. Each of the two gauges of the present kit may also serve as a compass, due to an external pivot recess formed at the origin point of the linear and/or angular scales, as appropriate. The pivot recess is placed about a nail or other pivot pin and rotated to form a circular arc or positioned to define an angle, as desired. The gauges or components of the present framing and layout kit may be formed of virtually any suitable material, but are preferably formed of a durable metal, such as stainless steel. Other less costly materials may be used alternatively, if so desired, e.g., aluminum, plastic, wood, etc.

These and other features of the present invention will become readily apparent upon further review of the following specification and drawings.

### BRIEF DESCRIPTION OF THE DRAWINGS

FIG. 1A is a fragmented top plan view of the protractor portion of the first component of a multipurpose framing and layout guide kit according to the present invention.

FIG. 1B is a fragmented top plan view of the opposite distal end of the linear scale portion of the first component of the multipurpose framing and layout guide kit.

FIG. 2 is an environmental perspective view of the kit component of FIGS. 1A and 1B in use to mark or scribe a line normal to a panel edge.

FIG. 3 is an environmental perspective view of the kit component of FIGS. 1A and 1B being used to mark or scribe a line parallel to a panel edge.

FIG. 4 is an environmental perspective view of the kit component of FIGS. 1A and 1B being used to mark or scribe a line at an acute angle to a panel edge.

FIG. 5 is a top plan view of the second, stud spacer gauge component of the present multipurpose framing and layout guide kit.

FIG. 6 is an environmental perspective view of the kit component of FIG. 5 in use as a stud spacer gauge.

Similar reference characters denote corresponding features consistently throughout the attached drawings.

### DETAILED DESCRIPTION OF THE PREFERRED EMBODIMENTS

The present invention comprises various embodiments of a multipurpose framing and layout guide kit for use in conventional frame building construction. While the present kit comprises two components, each component may be used separately if so desired, with it being understood that the overall function provided by the present kit is somewhat limited if only one of the components is used.

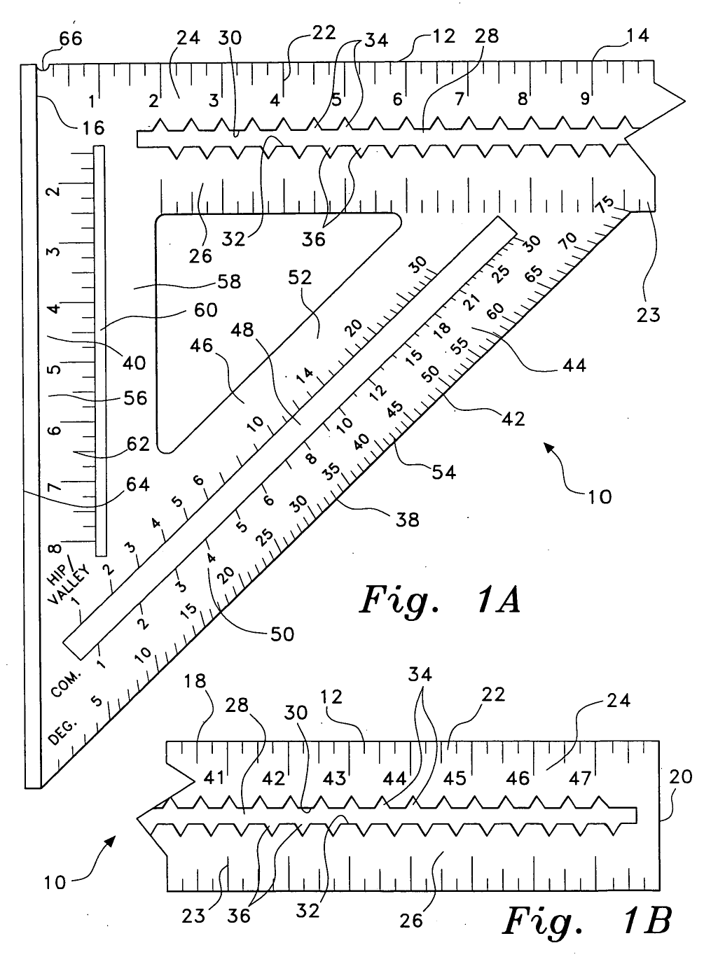

FIGS. 1A and 1B of the drawings provide top plan views of the two opposite end portions of a gable framing and layout guide 10 of the present kit. The guide 10 includes a flat, straight, elongate, rigid rule 12 having a first end portion 14 (of FIG. 1A) with a first end 16, and an opposite second end portion 18 (FIG. 1B) with a second end 20. A continuous linear measurement scale 22 (inches and feet, or metric, etc., as desired) extends from the first end 16 to the second end 20 of the rule 12. It will be understood that the intermediate portion of the rule 12, from about the nine-inch point of the scale 12 in FIG. 1A to about the forty-inch point of the scale 12 in FIG. 1B, is not shown in order to provide sufficient detail in the drawings while fitting both FIGS. 1A and 1B onto a single sheet. The scale 22 may include a supplemental, secondary fractional or other scale 23 along the opposite side of the rule 12, if so desired.

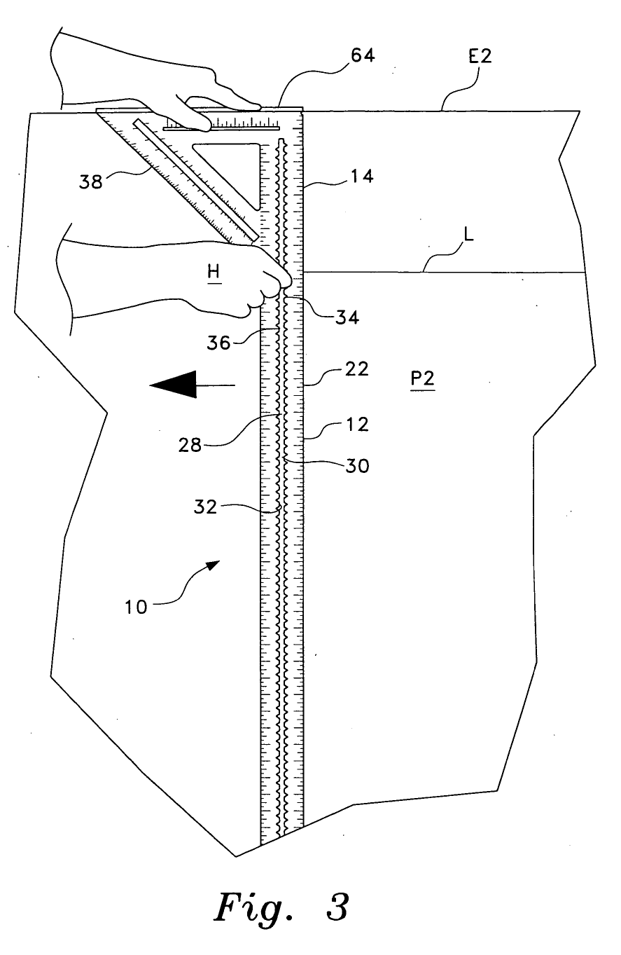

The rule 12 comprises a first side 24 and opposite second side 26, or upper and lower portions, with the two sides being separated by and defining a cutting and marking slot 28 therebetween. The slot 28 extends substantially the entire length of the rule 12, with the two sides 24 and 26 of the rule 12 being connected only at the extreme ends 16 and 20 of the rule 12. The slot 28 includes first and second opposed edges, respectively 30 and 32, with the slot edges 30 and 32 having a series of cutting and marking notches 34 and 36 disposed therealong. (Alternatively, the cutting and marking notches may be applied to only one of the slot edges 30 or 32, if so desired.) The cutting and marking notches 30 and 32 provide for the placement of a tool point (e.g., pencil, crayon, utility knife point, etc.) therein, with the tool point being held in place relative to the guide 10 by the selected notch as the guide 10 is moved over the workpiece. This procedure is illustrated in FIG. 3 and discussed further below.

The first end portion 14 of the rule 12 includes a right triangular protractor 38 extending therefrom, with the protractor 38 providing additional functions for the guide 10. The triangular protractor portion 38 is formed by a first leg comprising the first end portion 14 of the rule 12, a straight second leg 40 extending from the first end 16 of the rule 12 and normal thereto, and a straight hypotenuse 42 forming the third leg of the triangle 38. The hypotenuse 42 is preferably at a forty-five degree angle to the two legs 14 and 40, but may form other angles (e.g., thirty and sixty degrees, etc.) with the two legs 14 and 40, as desired.

The hypotenuse 42 of the triangle 38 is formed somewhat similarly to the rule 12, with the hypotenuse 42 having opposite first and second sides 44 and 46, which define a smooth, straight guide slot 48 therebetween. The guide slot 48 may be used to view the alignment of the edge of a gable member or other edge or line therethrough, for aligning the edge or line with a slope scale disposed along the slot 48. In the example of FIG. 1A, a hip and valley rafter slope scale 50 is provided along the first side 44 of the hypotenuse leg 42, with a common rafter scale 52 applied on the opposite side of the slot 48 to the second side 46 of the hypotenuse 42. A degree scale 54 may be applied to the hypotenuse 42 as well, e.g., along the outer edge of the first side 44 of the hypotenuse leg 42, as shown in FIG. 1A.

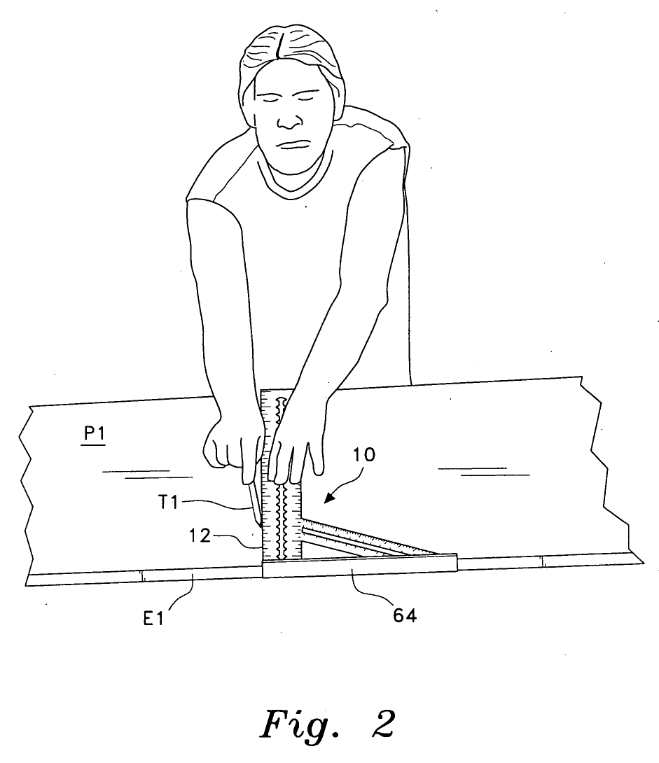

The second leg 40 of the triangular protractor 38 is configured somewhat like the hypotenuse 42, in that it is also formed of opposite first and second sides, respectively 56 and 58, which define a smooth, straight guide slot 60 therebetween. The second leg guide slot 60 may include a linear measurement scale 62 therealong on one of the two sides 56 or 58 of the second leg 40, as desired. The second leg 40 also includes a fence 64 extending substantially the entire length of the leg 40. All of the various components of the guide 10, excepting the fence 64, are coplanar with one another and define a relatively thin and flat plane. The fence 64 is normal to and extends in both directions beyond the plane of the remainder of the guide 10, for placement along the edge of a workpiece, as desired. This operation is illustrated in FIGS. 2 and 3 of the drawings, and discussed in detail further below.

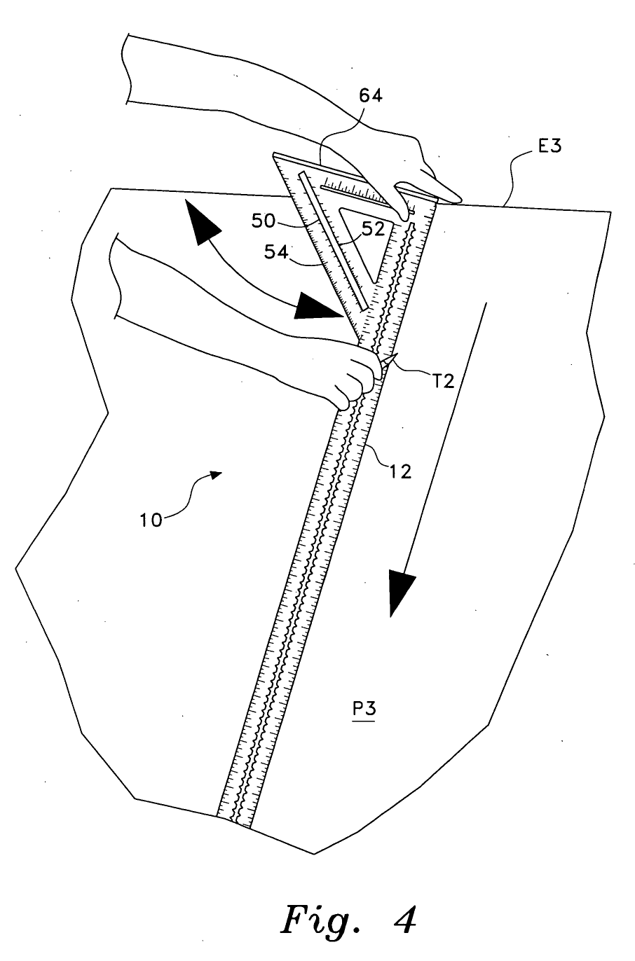

The protractor slope and angular degree scales 50, 52, and 54 all relate to an origin point located at the extreme first end 16 of the rule 12, along its outermost edge. A pivot detent 66 is formed in the edge of the rule 12 at this point, for pivoting about a fixed pin (nail, screw, etc.) in order to swing an arc using one of the cutting and marking notches 34 or 36, or to measure or mark a slope or angle using one of the scales 50 through 54. This procedure is shown generally in FIG. 4 of the drawings, and explained in detail further below.

The gable framing and layout guide 10 of the present kit provides a large number of functions in laying out, marking, and cutting or scoring various panels and structural members used in conventional frame building construction. FIG. 2 illustrates one means of using the present guide 10, to mark or cut a straight line normal to a panel edge. In FIG. 2, the device 10 has been placed atop a panel P1, with the fence 64 of the guide 10 resting along the edge E1 of the panel P1. The guide 10 may be slid across the surface of the panel P1 with the fence 64 running along the edge E1 of the panel until the edge of the rule 12 is positioned as desired, and the rule 12 edge used as a guide for a cutting or marking tool T1 to produce a line, score, or cut perpendicular to the edge E1 of the panel P1.

FIG. 3 illustrates another means of using the present guide 10, to form a line, cut, or score parallel to a panel edge. In FIG. 3, the fence 64 of the guide 10 has again been placed along the edge of a panel, e.g., the edge E2 of a panel P2. The cutting or marking tool (concealed within the hand H of the user of the tool in FIG. 3) is positioned within the desired guide notch 34 or 36, as desired. Each of the notches 34 and 36 is aligned with one of the units, or a major fraction thereof, of the linear measurement scale 22 disposed along the rule 12. Preferably, each row of notches 34 and 36 is offset from one another, in order to effectively double the number of alignment notches provided. In other words, the notches along each edge 30 and 32 of the slot 28 may be positioned e.g., one-half inch apart, with the notches 34 along the edge 30 being staggered one-quarter inch from the notches 36 of the edge 32. Other spacing may be used as desired. Once the cutting or marking tool has been positioned in the desired notch 34 or 36, the gable framing and layout guide 10 is drawn over the surface of the panel P2 with the fence 64 riding along the edge E2 of the panel. The tool resting within the selected notch 34 or 36 thus forms a mark, cut, or score line L along the panel P2, parallel to the edge E2 of the panel.

FIG. 4 of the drawings illustrates the use of the guide 10 in laying out a slope line across a panel P3. In FIG. 4, the end of the fence 64 coinciding with the immediately adjacent pivot detent 66 is placed on the edge E3 of the panel P3 at the origin location for the line, cut, or score to be made. The guide 10 is rotated about the pivot detent end of the fence 64 (a nail, screw, etc. may be used as a pivot point, as desired) until the desired slope (as measured using one of the two slope scales 50 or 52) or angle (as measured using the degree scale 54) is indicated relative to the panel edge E3. The guide 10 is held in this position as desired, and the mark, score, or cut is made using the edge of the rule 12 as a guide for the cutting, marking, or scoring tool T2.

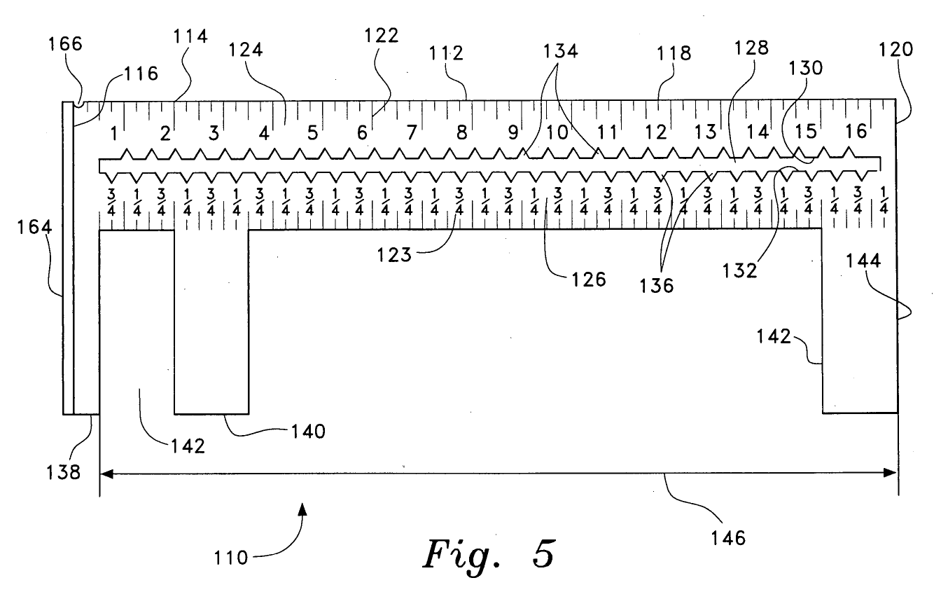

FIG. 5 provides a top plan view of the second component of the present kit, comprising a stud spacing guide 110. The stud spacing guide 110 comprises a flat, straight, elongate, rigid rule 112 having a first end portion 114 with a first end 116 and an opposite second end portion 118 with a second end 120. A continuous linear measurement scale 122 extends from the first end 116 to the second end 120 of the rule 112. The scale 122 may include a supplemental, secondary fractional or other scale 123 along the opposite side of the rule 112, if so desired.

The rule 112 comprises a first side 124 and opposite second side 126, or upper portion and lower portion, with the two sides being separated by and defining a cutting and marking slot 128 therebetween. The slot 128 extends substantially the entire length of the rule 112, with the two sides 124 and 126 of the rule 112 being connected only at the extreme ends 116 and 120 of the rule 112. The slot 128 includes first and second opposed edges, respectively 130 and 132, with the slot edges 130 and 132 having a series of cutting and marking notches 134 and 136 disposed therealong. (Alternatively, the cutting and marking notches may be applied to only one of the slot edges 130 or 132, if so desired.) The cutting and marking notches 130 and 132 serve the same purpose as the corresponding notches 30 and/or 32 of the gable framing and layout guide 10 of FIGS. 1 through 4, i.e., to provide for the placement of a tool point (e.g., pencil, crayon, utility knife point, etc.) therein, with the tool point being held in place relative to the guide 110 by the selected notch as the guide 110 is moved over the workpiece.

A first stud-gripping finger 138 extends from the first end 116 of the rule 112, normal thereto, with a parallel second stud-gripping finger 140 extending from the first end portion 114 of the rule 112 and spaced from the first finger 138. The two stud-gripping fingers 138 and 140 are spaced apart a predetermined distance to provide for a close fitting stud holding slot 142 about the minor dimension of a conventional framing stud, e.g., 1½ inches apart for standard cut 2×4 lumber stock. Other dimensions may be used as desired.

A stud-spacing finger 142 extends from the opposite second end 120 of the rule 112, with the stud-spacing finger 142 having a distal edge 144 aligned with the second end 120 of the rule 112. The distal edge 144 of the stud-spacing finger 142 is set at a predetermined stud-spacing distance 146 from the inboard edge of the first stud-gripping finger 138, e.g., sixteen inches, the standard stud spacing for frame construction in the U.S.A. Other spacing, e.g., twelve, eighteen, twenty-four inches, etc., may be used as desired by adjusting the span between the two stud-gripping fingers 138 and 140 and the stud-spacing finger 142. It will also be seen that the gap 142 between the two stud-gripping fingers 138 and 140 may be adjusted as desired, e.g., 3½ inches to fit nominally dimensioned 4×4 lumber stock, or three inches to fit about two 2×4s joined face-to-face.

The first stud-gripping finger 138 also includes a fence 164 extending substantially the entire length thereof, and defining the first end 116 of the rule 112. All of the various components of the guide 110, excepting the fence 164, are coplanar with one another and define a relatively thin and flat plane. The fence 164 is normal to and extends in both directions beyond the plane of the remainder of the guide 110, for placement along the edge of a workpiece as desired. This operation is illustrated in FIGS. 2 and 3 of the drawings for the gable framing and layout guide 10, with the function of the fence 164 of the stud spacing guide 110 being substantially similar.

As in the case of the gable framing and layout guide 10, the stud spacing guide 110 also includes a pivot detent 166 formed in the edge of the first end 116 of the rule 112 at the adjacent end of the fence 164. While no protractor, degree, or slope scales are provided in the stud spacing guide 110, the pivot detent provides for pivoting the guide 110 about a fixed pin (nail, screw, etc.) in order to swing an arc using one of the cutting and marking notches 134 or 136.

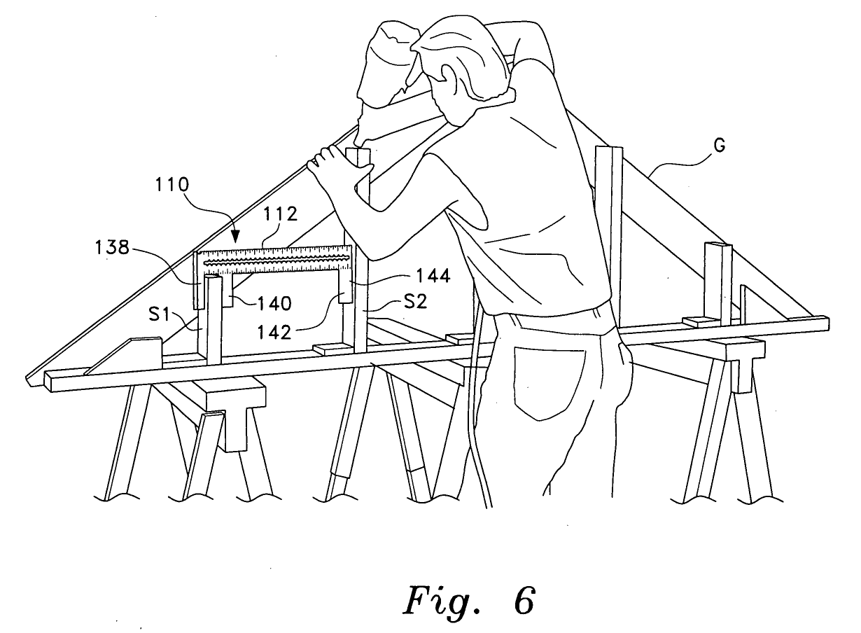

FIG. 6 illustrates the use of the stud spacing guide 110. In FIG. 6, a worker is prefabricating a gable G for later installation. The gable G includes conventional stud spacing, with a series of studs S1, S2, etc. being installed in the gable assembly G. The studs are spaced apart according to the desired standard, e.g., sixteen inches on center. The two stud-gripping fingers 138 and 140 of the stud spacing guide 110 have been placed about the end of a first stud S1, previously secured in position, with the opposite second end 120 of the guide and its stud-spacing finger 142 extending to the right of the first stud S1 in FIG. 6. The second stud S2 need only be positioned in contact with the distal edge 144 of the stud-spacing finger 142 to assure the proper spacing between the two studs S1 and S2 to allow the worker to secure the second stud S2 accurately in position.

In conclusion, the present multipurpose framing and layout kit provides a great number of different functions and operations required by carpenters and workers in the construction of conventional gabled frame structures. While the two components of the present kit are most optimally used in concert with one another for optimum efficiency, it will be seen that some of their individual functions are well suited for use in carrying out various individual tasks and operations in building construction, and may be used separately from one another. However, the present kit with its gable framing and layout guide and stud spacing guide greatly improves the ability of the carpenter or worker on the jobsite to carry out a number of tasks and operations conventionally handled in the construction of gabled frame structures. The reduction in the number of complex tools and devices otherwise required by the carpenter or worker will be greatly appreciated by those involved in such work.

It is to be understood that the present invention is not limited to the embodiments described above, but encompasses any and all embodiments within the scope of the following claims.

I claim:

1. A multipurpose framing and layout guide kit, comprising:
a gable framing and layout guide, including:
a flat, straight, elongate, rigid rule having at least one continuous linear measurement scale thereon, a first end and first end portion, a second end and second end portion opposite the first end and first end portion, a first side, and a second side opposite the first side, the first side and second side defining a cutting and marking slot therebetween extending substantially from the first end to the second end thereof, the slot having a first edge and a second edge opposite the first edge, a plurality of cutting and marking notches being defined along at least one of the edges; and
a right triangular protractor portion, the first end portion of said rule defining a first leg of the protractor portion, the protractor portion having a straight second leg extending from the first end of said rule normal thereto and a straight hypotenuse extending between the first leg and the second leg;
a stud spacing guide, including:
a flat, straight, elongate, rigid rule having at least one continuous linear measurement scale thereon, a first end and first end portion, a second end and second end portion opposite the first end and first end portion, a first side, and a second side opposite the first side, the first side and second side defining a cutting and marking slot therebetween extending substantially from the first end to the second end thereof, the slot having a first edge and a second edge opposite the first edge, a plurality of cutting and marking notches being defined along at least one of the edges;
a first stud-gripping finger extending from the first end of said rule normal thereto;
a second stud-gripping finger extending from the first end portion of said rule, spaced apart from and parallel to said first stud-gripping finger, said first and said second stud-gripping fingers defining a stud holding slot therebetween; and
a stud-spacing finger extending from the second end of said rule, said stud-spacing finger having a distal edge, the stud holding slot and the distal edge of said stud-spacing finger defining a predetermined stud space therebetween.

2. The multipurpose framing and layout guide kit according to claim 1, wherein said rule and said protractor portion of said gable framing and layout guide define a thin, flat plane, the second leg of said protractor portion further including a fence extending therealong, normal to the plane of said protractor portion and said rule, the fence extending beyond the plane.

3. The multipurpose framing and layout guide kit according to claim 1, further including a pivot detent formed in the first end of said rule of said gable framing and layout guide.

4. The multipurpose framing and layout guide kit according to claim 1, wherein the second leg of said protractor portion of said gable framing and layout guide has a first side and a second side opposite the first side defining a smooth, straight guide slot therebetween.

5. The multipurpose framing and layout guide kit according to claim 1, further including a linear measurement scale disposed along the second leg of the protractor portion of said gable framing and layout guide.

6. The multipurpose framing and layout guide kit according to claim 1, wherein the hypotenuse of the protractor portion of said gable framing and layout guide has a first side and a second side opposite the first side defining a smooth, straight guide slot therebetween.

7. The multipurpose framing and layout guide kit according to claim 1, further including an angular degree scale disposed along the hypotenuse of the protractor portion of said gable framing and layout guide.

8. The multipurpose framing and layout guide kit according to claim 1, further including at least one rafter slope scale disposed along the hypotenuse of the protractor portion of said gable framing and layout guide.

9. The multipurpose framing and layout guide kit according to claim 1, wherein said rule, said first stud-gripping finger, said second stud-gripping finger, and said stud-spacing finger of said stud spacing guide define a thin, flat plane, said first stud gripping finger having a fence extending therealong normal to the plane of said rule.

10. The multipurpose framing and layout guide kit according to claim 1, further including a pivot detent formed in the first end of said rule of said stud spacing guide.

11. A gable framing and layout guide, comprising:
a flat, straight, elongate, rigid rule having at least one continuous linear measurement scale thereon, a first end and first end portion, a second end and second end portion opposite the first end and first end portion, a first side, and a second side opposite the first side, the first side and second side defining a cutting and marking slot therebetween extending substantially from the first end to the second end thereof, the slot having a first edge and a second edge opposite the first edge, a plurality of cutting and marking notches being defined along at least one edge; and
a right triangular protractor portion, the first end portion of said rule defining a first leg of the protractor portion, the protractor portion having a straight second leg extending from the first end of said rule normal thereto and a straight hypotenuse extending between the first leg and the second leg.

12. The gable framing and layout guide according to claim 11, wherein said rule and said protractor portion define a thin, flat plane, the second leg of said protractor portion having a fence extending therealong normal to the plane of said protractor portion and said rule, the fence extending beyond the plane.

13. The gable framing and layout guide according to claim 11, further including a pivot detent formed in the first end of said rule.

14. The gable framing and layout guide according to claim 11, wherein the second leg of said protractor portion has a first side and a second side opposite the first side, the first and second sides defining a smooth, straight guide slot therebetween.

15. The gable framing and layout guide according to claim 11, further including a linear measurement scale disposed along the second leg of said protractor portion.

16. The gable framing and layout guide according to claim 11, wherein the hypotenuse of said protractor portion has a first side and a second side opposite the first side, the first and second sides defining a smooth, straight guide slot therebetween.

17. The gable framing and layout guide according to claim 11, further including an angular degree scale disposed along the hypotenuse of said protractor portion.

18. The gable framing and layout guide according to claim 11, further including at least one rafter slope scale disposed along the hypotenuse of said protractor portion.

19. A stud spacing guide, comprising:
a flat, straight, elongate, rigid rule having at least one continuous linear measurement scale thereon, a first end and first end portion, a second end and second end portion opposite the first end and first end portion, a first side, and a second side opposite the first side, the first side and second side defining a cutting and marking slot therebetween extending substantially from the first end to the second end thereof, the slot having a first edge and a second edge opposite the first edge, a plurality of cutting and marking notches being disposed along at least one of the edges;
a first stud-gripping finger extending from the first end of said rule normal thereto;
a second stud-gripping finger extending from the first end portion of said rule, spaced apart from and parallel to said first stud-gripping finger, said first and said second stud-gripping fingers defining a stud-holding slot therebetween; and
a stud-spacing finger extending from the second end of said rule, said stud spacing finger having a distal edge, the stud-holding slot and the distal edge of said stud-spacing finger defining a predetermined stud space therebetween.

20. The stud spacing guide according to claim 19, wherein said rule, said first stud-gripping finger, said second stud-gripping finger, and said stud-spacing finger define a thin, flat plane, said first stud-gripping finger having a fence extending therealong normal to the plane of said rule, the first end of said rule having a pivot detent formed therein adjacent the fence.
